(19) United States
(12) Patent Application Publication
(10) Pub. No.: US 2016/0167281 A1
(43) Pub. Date: Jun. 16, 2016

(54) BLOW MOLDING MOLD AND BLOW MOLDING PRODUCT FABRICATED WITH SAME

(71) Applicant: NADFINLO PLASTICS INDUSTRY (SHENZHEN) CO.,LTD., Shenzhen, Guangdong (CN)

(72) Inventors: Wai Shing Sze, Hong Kong (HK); Sun Tat Ng, Hong Kong (HK)

(73) Assignee: NADFINLO PLASTICS INDUSTRY (SHENZHEN) CO., LTD., Shenzhen, Guangdong (CN)

(21) Appl. No.: 14/380,383

(22) PCT Filed: Jun. 13, 2014
(86) PCT No.: PCT/CN2014/079810

§ 371 Date: Aug. 22, 2014

(30) Foreign Application Priority Data
Jun. 13, 2013 (CN) 201320337021.3

(51) Int. Cl. B29C 49/48; B25H 3/02; B25H 3/00

(52) U.S. Cl. CPC B29C 49/4815; B25H 3/006; B25H 3/02; B29K 2105/253

(57) ABSTRACT

The present application provides a blow molding mold and a blow molding product fabricated with same. The blow molding mold includes two mold halves, where one mold half is provided with a slide path penetrating through the wall of the mold half, and the slide path is arranged at a position corresponding to a part, on which an adhesion reinforcing structure needs to be formed, of a blow molding product; the blow molding mold further includes a pressing block and a driving apparatus, where the pressing block fits with the slide path in a sliding manner and is used to exert a pressing force on an injected hollow parison so that the adhesion reinforcing structure where inner and outer walls bond together is formed at a pressed position of the fabricated blow molding product. The blow molding product is highly firm on the part of the adhesion reinforcing structure.

### BACKGROUND

1. Technical Field

The present application relates to a blow molding mold and a corresponding blow molding product.

2. Related Art

Blow molding is also referred to as hollow blow molding, and an extrusion blow molding process generally includes the following steps: 1. extruding plastic into a hollow plastic tube, to form a parison; 2. closing a split mold with the parison inside, clamping the mold, and cutting off the parison; 3. blowing air into the parison so that the parison inflates towards the cold wall of a mold cavity, and adjusting an opening and maintaining certain pressure during cooling; 4. opening the mold, and taking out a blown product; and 5. trimming off flashes to obtain a finished blow molding product. Well-known blow molding products include bottles, barrels, cans, boxes, and containers for packaging food, beverages, cosmetics, medicine, or daily necessities. A blow molding product, such as a toolbox, is required to have a drop test on edges and corners before leaving a factory. The blow molding product is hollow on every part; therefore, corner positions may dent after the drop test. As a result, inner and outer walls at the corner positions are too close, which results in fruitless; or the corner positions are too thin for the process reason, thereby affecting use of the blow molding product.

### SUMMARY

An objective of the present application is to provide a blow molding mold that can be used to fabricate a blow molding product by blow molding, where an adhesion reinforcing structure where inner and outer walls bond together is formed on some parts of the blow molding product, such as edges and corners.

The technical solution used in the present application is as follows: A blow molding mold includes two mold halves, where a mold half is provided with a slide path penetrating through the wall of the mold half, and the slide path is arranged at a position corresponding to a part, on which an adhesion reinforcing structure needs to be formed, of a blow molding product; the blow molding mold further includes a pressing block and a driving apparatus, where the pressing block fits with the slide path in a sliding manner and is used to exert a pressing force on an injected hollow parison so that the adhesion reinforcing structure where inner and outer walls bond together is formed at a pressed position of the fabricated blow molding product, and the driving apparatus drives the pressing block to slide along the slide path; and a surface profile of an inner end, extending into the mold half, of the pressing block is consistent with a surface profile of a part, removed to form the slide path, of the mold half.

Preferably, the blow molding mold is a toolbox blow molding mold; and a mold half, corresponding to an inner cavity of a toolbox, of the toolbox blow molding mold is provided with the slide path at a position corresponding to at least one corner of the toolbox.

Another objective of the present application is to provide a blow molding product corresponding to the blow molding mold.

The technical solution used in the present application is as follows: A blow molding product fabricated with the blow molding mold is provided, where inner and outer walls of the blow molding product bond together at a position aligned with the pressing block and along a sliding direction of the pressing block, so as to form the partially closed adhesion reinforcing structure.

Preferably, the blow molding mold is a toolbox blow molding mold; and a mold half, corresponding to the inner cavity of a toolbox, of the toolbox blow molding mold is provided with a slide path at a position corresponding to at least one corner of the toolbox; and the adhesion reinforcing structure is formed in a corner of the toolbox aligned with each pressing block.

Beneficial effects of the present application are as follows: In the present application, the design of an existing blow molding mold is improved, and an adhesion reinforcing structure where the inner and outer walls bond together can be formed on a part of the blow molding product as required. Consequently, the blow molding product is highly firm on the part of the adhesion reinforcing structure; therefore, a main stressed part, such as a corner position, does not dent because of a drop test or use.

### BRIEF DESCRIPTION OF THE DRAWINGS

FIG. 1 is a front view of a toolbox blow molding mold according to an embodiment of a blow molding mold of the present application;

FIG. 2a is a sectional view of the toolbox blow molding mold shown in FIG. 1 along a C-C direction after a parison is injected;

FIG. 2b is a sectional view of the toolbox blow molding mold shown in FIG. 1 along the C-C direction when a pressing block exerts a pressing force after the process in FIG. 2a is completed;

FIG. 2c is a sectional view of the toolbox blow molding mold shown in FIG. 1 along the C-C direction when the pressing block exits after the process shown in FIG. 2b is completed;

FIG. 3 is a front view of a toolbox fabricated with the toolbox blow molding mold shown in FIG. 1;

FIG. 4 is a sectional view of FIG. 3 in a B-B direction, where a B-B sectional position is the same as a C-C sectional position; and

FIG. 5 is a sectional view of FIG. 3 in an A-A direction, where an A-A sectional position is the same as a C-C sectional position.

### DETAILED DESCRIPTION

Specific implementation manners of the present application are further described with reference to accompanying drawings.

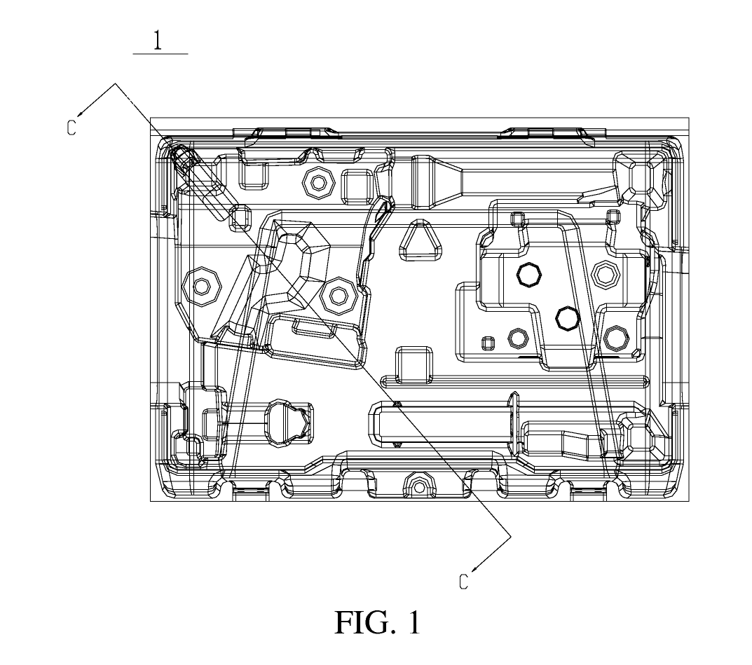

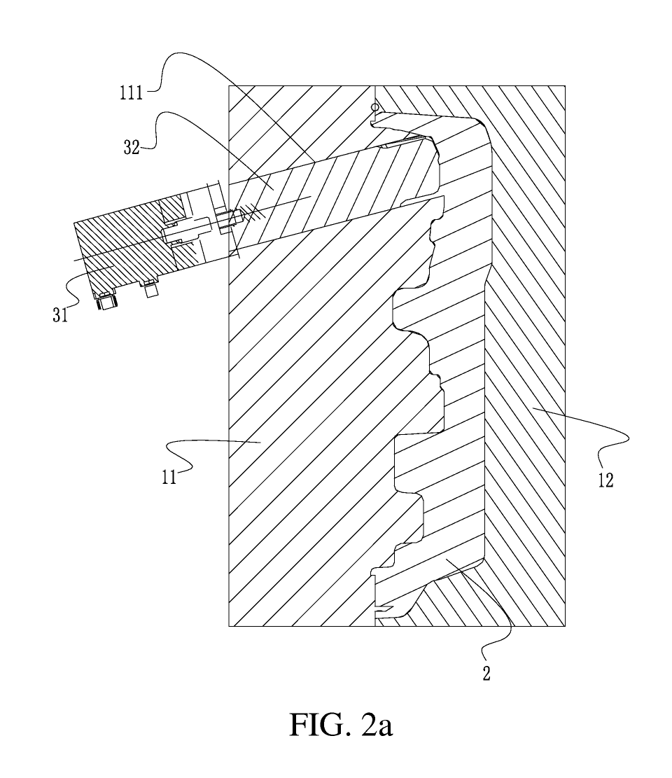

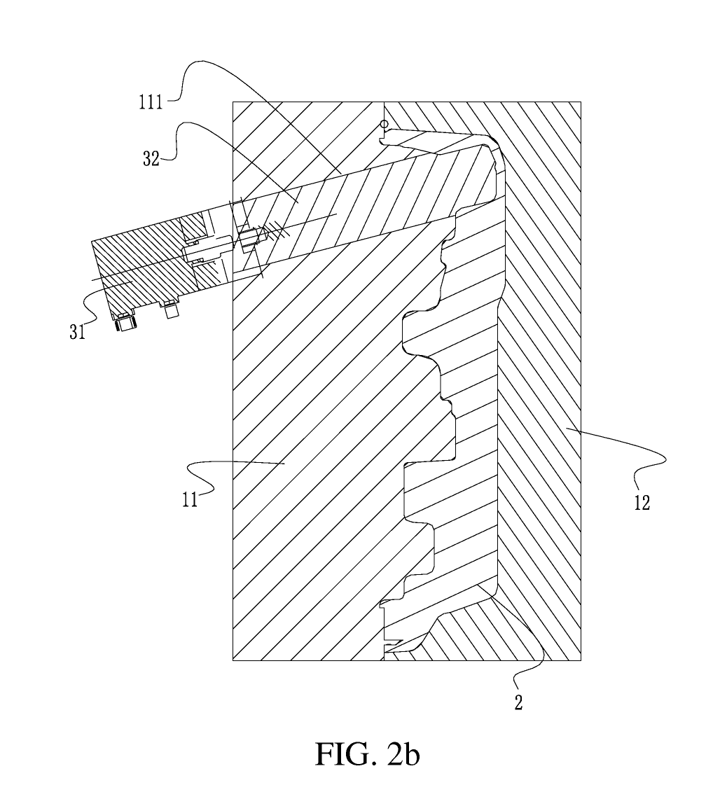

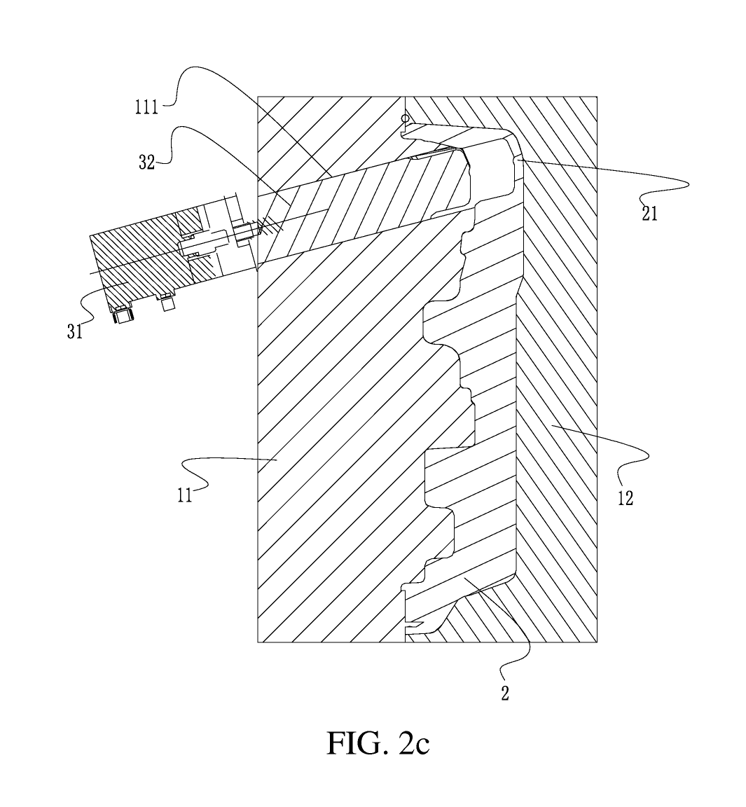

FIG. 1 and FIG. 2a to FIG. 2c show a toolbox blow molding mold 1 for fabricating a toolbox by blow molding. The toolbox blow molding mold includes two mold halves 11 and 12, and the mold half 11 corresponding to an inner cavity of the toolbox is provided with a slide path 111 penetrating through the wall of the mold half 11. The toolbox blow molding mold further includes a pressing block 32 that fits with the slide path 111 in a sliding manner, and a driving apparatus 31 for driving the pressing block 32 to slide along the slide path 111 to exert a pressing force. The driving apparatus 31 is, for example, a hydraulic driving apparatus such as an oil cylinder, and the driving apparatus 31 can exert, under the control of a control system of a blow molding machine, a pressing force on a hollow parison injected into the toolbox blow molding mold, so that an adhesion reinforcing structure where inner and outer walls bond together is formed at a pressed position of the finally formed toolbox. Therefore, it can be seen that the location and a tilting direction of the slide path 111 are designed according to a part, on which the adhesion reinforcing structure needs to be formed, of the blow molding product. A person skilled in the art may improve various existing blow molding molds according to the foregoing structure as required. Because a finally formed profile shape of the blow molding product cannot be changed, a surface profile of an inner end, extending into the mold half 11, of the pressing block 32, is basically consistent with a surface profile of a part, removed to form the slide path 111, of the mold half 11. During operation, the driving apparatus 31 drives the pressing block 32 to bond the walls of the glutinous parison at a specific position. This operation may be performed along with blowing, and the blow molding product may be formed after cooling.

In the toolbox blow molding mold 1 shown in FIG. 1 and FIG. 2a to FIG. 2c, the mold half 11 is provided with the slide path corresponding to at least one corner 21 of a toolbox 2, that is, a tilting direction of the slide path is consistent with a direction of a connection line between the inner and outer walls of the toolbox 2 at the corner 21. No section line representing the toolbox 2 in the accompanying drawings indicates that the toolbox has a solid structure in the section, the section line is only used to clearly show a profile shape of the toolbox 2 in the section, and only the corner 21 in the accompanying drawings is a solid structure or is referred to as a closed structure as shown by the section line.

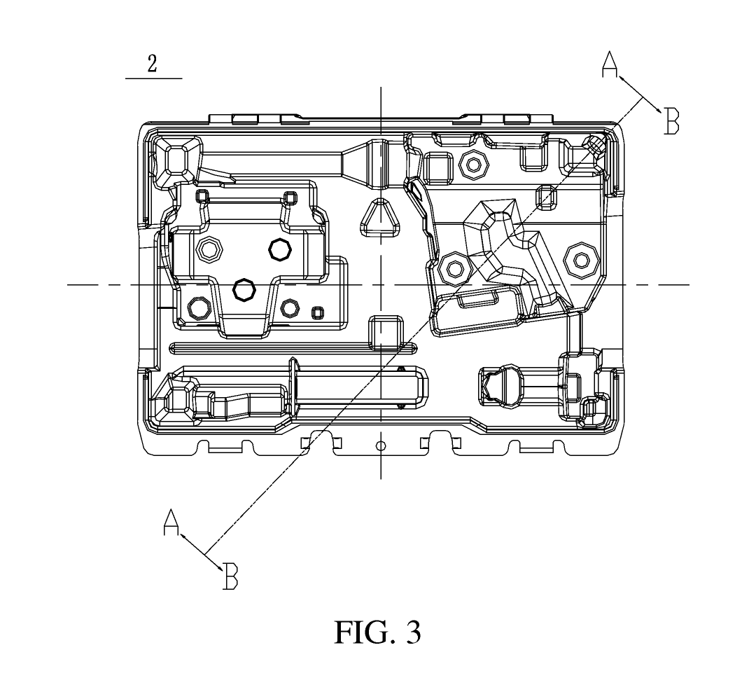

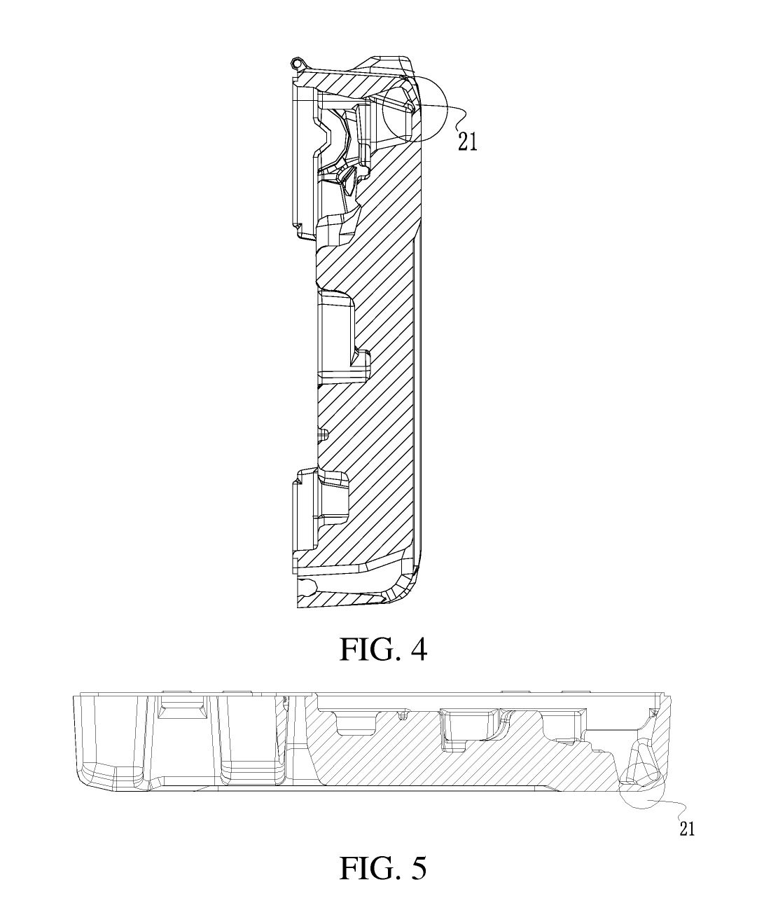

The toolbox 2 fabricated with the toolbox blow molding mold 1 is shown in FIG. 3 to FIG. 5, where the needed adhesion reinforcing structure is formed in the corner 21 of the toolbox 2 aligned with the pressing block 32.

The foregoing descriptions are merely exemplary embodiments of the present application, but are not intended to limit the implementation scope of the present application. Any equivalent variation or modification made within the protection scope disclosed in the present application shall fall within the protection scope of the present application.

What is claimed is:

1. A blow molding mold, comprising two mold halves, wherein a mold half is provided with a slide path penetrating through a wall of the mold half, and the slide path is arranged at a position corresponding to a part, on which an adhesion reinforcing structure needs to be formed, of a blow molding product; the blow molding mold further comprises a pressing block and a driving apparatus, wherein the pressing block fits with the slide path in a sliding manner and is used to exert a pressing force on an injected hollow parison so that the adhesion reinforcing structure where inner and outer walls bond together is formed at a pressed position of the fabricated blow molding product, and the driving apparatus drives the pressing block to slide along the slide path; and a surface profile of an inner end, extending into the mold half, of the pressing block is consistent with a surface profile of a part, removed to form the slide path, of the mold half.

2. The blow molding mold according to claim 1, wherein the blow molding mold is a toolbox blow molding mold; and the mold half, corresponding to an inner cavity of a toolbox, of the toolbox blow molding mold is provided with the slide path at a position corresponding to at least one corner of the toolbox.

3. A blow molding product fabricated with the blow molding mold according to claim 1, wherein inner and outer walls of the blow molding product bond together at a position aligned with the pressing block and along a sliding direction of the pressing block, so as to form a partially closed adhesion reinforcing structure.

4. The blow molding product according to claim 3, wherein the blow molding mold is a toolbox blow molding mold; and the mold half, corresponding to an inner cavity of a toolbox, of the toolbox blow molding mold is provided with a slide path at a position corresponding to at least one corner of the toolbox; and the adhesion reinforcing structure is formed in a corner of the toolbox aligned with each pressing block.
